(19) United States
(12) Patent Application Publication
(10) Pub. No.: US 2006/0085819 A1
(43) Pub. Date: Apr. 20, 2006

(54) Method and apparatus for content metadata search

(76) Inventors: Timo Bruck, Mountain View, CA (US); Thomas R. Hammer, San Mateo, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/966,393

(22) Filed: Oct. 14, 2004

(51) Int. Cl. H04N 5/445; G06F 13/00; H04N 7/173

(52) U.S. Cl. 725/52; 725/53; 725/37; 725/109

(57) ABSTRACT

A virtual dictionary contains keywords extracted from metadata describing multimedia content. A virtual keyboard of alphanumeric characters is configured for display on a display device such that as a character is selected from the virtual keyboard using navigation and selection controls associated with a set-top appliance only those alphanumeric characters which appear in sequence in one or more of the keywords contained in the virtual dictionary are displayed on the display device for a next selection.

### FIELD OF THE INVENTION

The invention relates generally to the fields of video on demand (VOD) and user search of a program guide. In one exemplary aspect, the invention relates to an apparatus and a method to assist in keyword searches of content available to a download-and-view VOD set-top appliance by presenting a limited set of characters on an onscreen keyboard.

### BACKGROUND OF THE INVENTION

Searching for content of interest is an important function in determining a user's satisfaction with a video service. Various techniques exist in the conventional art to perform such search using keywords, when information about the content is available in computer-readable digital form. For example, a user could search video content using search criteria for a particular actor or release year or “top 100” titles and so on.

Most viewers watch their VOD content using a television as the display device. Conventional art also specifies a television to present the user interfaces to perform content search. It is typical to use a remote control as the input device to interact with a search application that uses television to display the user interface.

When a remote control does not come equipped with alphanumeric keys, various techniques are used in the conventional art to enable a user input of search word terms via the user interface. For example, some conventional implementations offer an onscreen keyboard that gives the user an option to scroll to the appropriate input character and select it using navigation and selection controls of a remote control to simulate a keyboard key-press.

Such conventional methods suffer from several limitations. For example, since television is not a suitable device to display text, especially if a lot of textual information is to be presented, a keyboard made up of many characters tends to clutter the display and makes it difficult to read on smaller sized televisions. Additionally, because of the grid nature of television displays, user must press several navigation keys before being able to select a character.

Based on the foregoing, the present inventors have recognized there is a need for a visually terse method and apparatus to help a user perform efficient content searches by inputting search terms guaranteed to match an entry with limited key presses of navigation keys of a remote control while using a television as the display device.

### SUMMARY OF THE INVENTION

The present invention addresses the foregoing needs by providing, in various embodiments, a method and apparatus for searching metadata associated with multimedia content.

In a first aspect of the invention, a user interface that includes a virtual dictionary containing keywords extracted from metadata describing multimedia content available for download to a set-top appliance communicatively coupled with a display device is disclosed. In one embodiment, a virtual keyboard of alphanumeric characters is configured for display on the display device such that as a character is selected from the virtual keyboard using navigation and selection controls associated with the set-top appliance only those alphanumeric characters which appear in sequence in one or more of the keywords contained in the virtual dictionary are displayed on the display device for a next selection.

In a second aspect of the invention, a method for displaying, in response to a selection of an alphanumeric character from a virtual keyboard, only those alphanumeric characters which appear in sequence in one or more of keywords contained in a virtual dictionary, which keywords were extracted from metadata describing multimedia content available for download to a set-top appliance communicatively coupled to a display device on which the virtual keyboard is displayed, is disclosed. In one embodiment, when the choice of possible dictionary entries is sufficiently narrowed down, the display device shows possible dictionary entry choices for selection.

In a third aspect of the invention, a method of searching for multimedia content available for download via the Internet by entering a search query using a virtual keyboard of a set-top appliance is disclosed. The virtual keyboard is displayed via a display device coupled with the set-top appliance and configured such that as each character is selected from the virtual keyboard only those alphanumeric characters that appear in sequence in one or more keywords contained in a virtual dictionary are displayed on the display device for a next selection.

### BRIEF DESCRIPTION OF THE DRAWINGS

The above and other features and advantages of the present invention are hereinafter described in the following detailed description of illustrative embodiments to be read in conjunction with the accompanying drawings and figures, wherein like reference numerals are used to identify the same or similar system parts and/or method steps, and in which:

FIG. 1 illustrates a set-top appliance connected to the Internet, a television and communicatively coupled with a wireless remote control such that the remote control is used as the input device to perform keyword searches of metadata in accordance with an embodiment of the present invention.

FIG. 2 illustrates an example of a text input window, a virtual dictionary sorted alphabetically, and a virtual keyboard displaying some of the possible next characters constructed from the virtual dictionary in an active display window of a user interface configured in accordance with an embodiment of the present invention.

FIG. 3 illustrates a flow chart of steps taken according to an embodiment of the present invention during the process of metadata searching by entering words using navigation keys of a remote control.

### DETAILED DESCRIPTION

Reference is now made to the drawings wherein like numerals refer to like parts throughout.

As used herein, the term “content” refers to audio, video, graphics files (in uncompressed or compressed format), icons, software, text files and scripts, data, binary files and other computer-usable data used to operate a client device and produce desired audio-visual effects on a client device for the viewer.

As used herein, the term “metadata” refers to computer readable textual or graphical information associated with a content used to describe the content or enhance viewing experience. This includes, without limitations, cast, release date, director, story, reviews, content advisory ratings, etc. Metadata could either be embedded within the bitstream of the content, or be present in independent form. Metadata could further include information regarding abstract grouping of content (e.g. “best of 1999”, “Top 10”).

In view of the above, it should be appreciated that some portions of the detailed description that follows are presented in terms of algorithms and symbolic representations of operations on data within a computer memory. These algorithmic descriptions and representations are the means used by those skilled in the computer science arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. It should be borne in mind, however, that all of these and similar terms are to be associated with the appropriate physical quantities and are merely convenient labels applied to these quantities. Unless specifically stated otherwise, it will be appreciated that throughout the description of the present invention, use of terms such as “processing”, “computing”, “calculating”, “determining”, “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention can be implemented with an apparatus to perform the operations described herein. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and processes presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor or by any combination of hardware and software. One of ordinary skill in the art will immediately appreciate that the invention can be practiced with computer system configurations other than those described below, including hand-held devices, multiprocessor systems, microprocessor-based or programmable consumer electronics, DSP devices, network PCs, minicomputers, mainframe computers, and the like. The invention can also be practiced in distributed computing environments where tasks are performed by remote processing devices that are linked through a communications network. The required structure for a variety of these systems will appear from the description below.

The methods of the present invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, etc.), as taking an action or causing a result. Such expressions are merely a shorthand way of saying that execution of the software by a computer causes the processor of the computer to perform an action or produce a result.

### DESCRIPTION OF EXEMPLARY EMBODIMENTS

Exemplary embodiments of the method and apparatus of the present invention are now described in detail.

Download-and-View Video on Demand

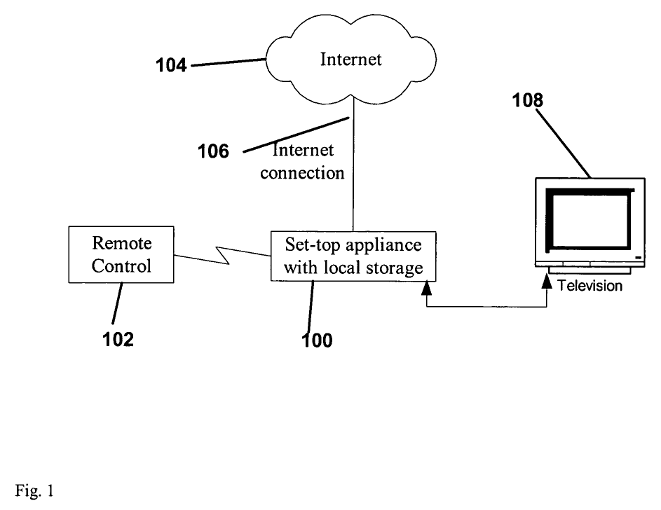

The present invention is now described using an example download-and-view video system shown in an exemplary embodiment in FIG. 1. In the embodiment shown in FIG. 1, a set-top appliance with local storage capability (100) is connected to the Internet (104) via an Internet connection (106). User interaction with the set-top appliance is performed with the help of a remote control (102) communicatively coupled with the set-top appliance and using a television (108) connected to the set-top appliance as the display device. The set-top appliance (100) is authorized to communicate with a video-on-demand (VOD) service provider's servers within the Internet cloud to obtain multimedia content and metadata information (e.g. program guide) related to content availability. Typically, a user would search available programs (e.g., programs cached locally or available on servers managed by the VOD service provider or its partners) using navigation keys of the remote control (102) (e.g., up/down/left/right scroll keys). To enter a text string for searching through the content metadata, assistance is provided to the user by displaying a set of characters (a “virtual keyboard”) on the television display. The user inputs a word or phrase by choosing and entering characters of the word, one at a time, from the virtual keyboard. The details of which keys are pressed to navigate through the virtual keyboard, what controls are implemented on the remote control to indicate entering a character in the search field are not materially significant to the present invention. Similarly the step of entering a word or phrase may be terminated explicitly by the user, or may be automatically terminated by the application responding to the key presses.

Metadata Search Process

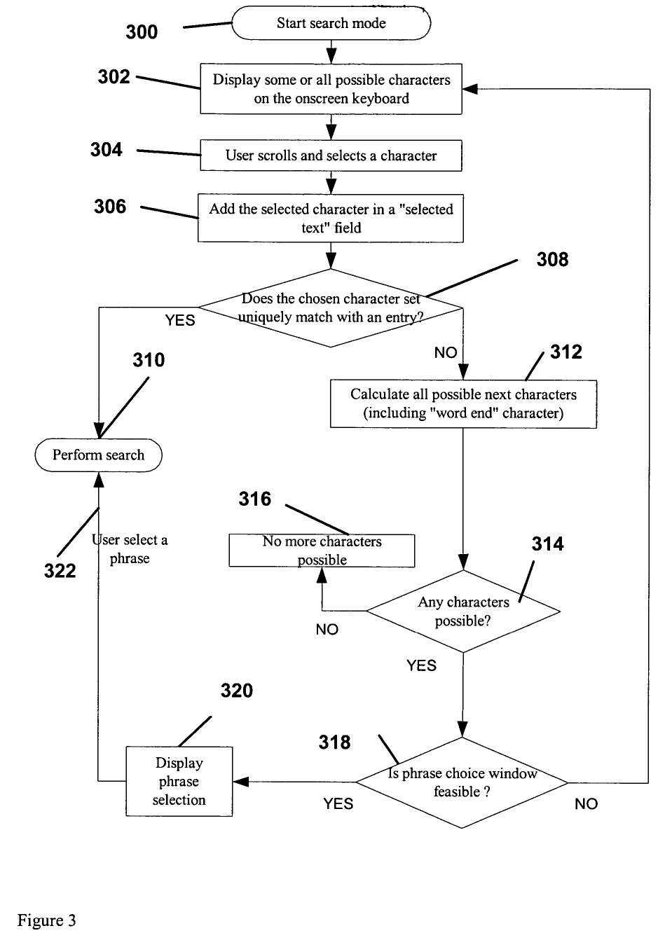

The algorithmic steps implemented in an exemplary embodiment of the method of present invention are now described. Referring to FIG. 3, Step 300 indicates the start of a metadata search by the user. A virtual keyboard is displayed on the screen showing some or all of the possible characters a user can select (step 302). Typically, the user scrolls over the virtual keyboard using navigation keys on a remote control and chooses a character to enter in the search field (304). When the user selects a character, it is displayed in a field of selected characters (306). A check is then performed (308) to match the possible partial words or expression made up by all previous key presses in the search with entries in a database suitably organized (e.g., alphabetically) and all keywords from metadata of all available programs. If there is a match, step 310 is executed to perform a search of the metadata using the search word thus entered. In some cases, an intermediate step to confirm the user's desire to perform the search may be included. This is especially useful when one keyword is made up of a first set of characters that correspond to another keyword.

If no match is obtained in 308, a set of all possible next characters is computed (312). If this set is empty (see decision box 314), this implies a complete search word has already been typed in, with no need to continue the process of displaying characters for further selection. A search of the database using the word thus entered is performed in step 316. If, however, in step 314, it is determined that one or more characters are possible next entries, this set is computed. In one embodiment of the invention, a display of some or all possible phrases is offered if the user input so far meets some criteria (318), For example, in many cases, after a user has type the first three characteristics of a word, the choice of subsequent complete phrase or word that has these three characters in the beginning positions is minimal. Therefore, in one embodiment, when a user types in the first three characters, a menu of possible words from the dictionary is displayed for the user to navigate and choose from (320). This menu may or may not contain all possible entries and thus may contain facility to scroll up or down the list of dictionary entries. When the user makes a selection from this menu (322), search step 310 is executed. If for some reason, it is determined that phrase display is not possible (e.g., there is a need to further narrow down by typing more characters), the limited character set from step 312 is used to display the virtual keyboard as in step 302 and the process is repeated.

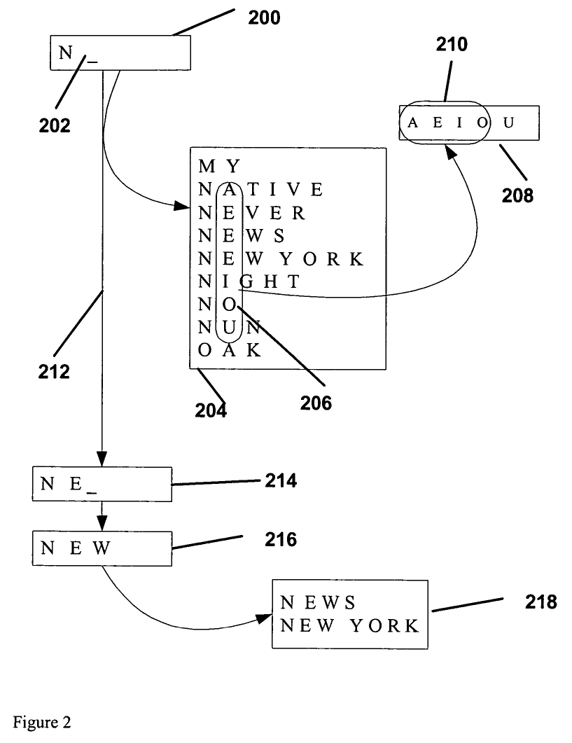

An exemplary embodiment of this algorithm is shown in FIG. 2. The box 200 shows a search field that displays to the user a partial word or phrase entered so far. Space 202 indicates the location where the next selected character will be displayed. When the character “N” is input as shown in 200, a search is made of a virtual dictionary 204 shown as alphabetically arranged entries of all the keywords in the metadata. As shown in 206, the earlier entered character “N” can now be appended by one of “A”, “E”, “I”, “O” or “U” so that the partial word entered thus could be completed as one of the entries of the dictionary. These possible choices of next characters are represented as a horizontal arrangement of characters in the virtual keyboard 208. In the illustrated embodiment, only some of all the possible characters are displayed in the actual display window 210, with the user having navigation capability to scroll and expose in the active display other possible characters. The decision regarding placement of characters in the active display window can be done using various criteria such as alphabetical ordering, the user's preferences and viewing history, promotional considerations and so on. The arrow labeled 212 in FIG. 2 shows that when the user selects character “E”, the character display field is modified to display “N E” (214). Carrying the process one step further, “N E W” will be displayed in the character display field (216) if the user selects character “W” next. In one exemplary embodiment, when three characters are input by the user (as is the case in step 216), the character display field may transition to a menu of all possible phrases that begin with the previously selected characters. This is shown in window 218 of FIG. 2. The transition from display 214 to 218 may be made either by momentarily displaying display of step 216, or without displaying 216 at all. Once the choice of dictionary entries is displayed, the user can choose an appropriate entry for the search.

Virtual Dictionary

The virtual dictionary can be made up of keywords in the metadata stored about the program. This metadata may include, but is not limited to, the following: Title, Cast, Description, Rating and Provider. It may be modified to include user-specified words and/or search terms (e.g., abbreviations).

Virtual Keyboard

As used in herein, the term “virtual keyboard” refers to a placement of various characters on the display for the user to scroll through and select. No particular visual details of placement, font, color, and graphical icons are critical to the present invention. In one exemplary embodiment, the virtual keyboard can be implemented as a row or endless loop of characters placed in a text box, with the ability to scroll to the left of the box and to the right of the box thus exposing more choice of characters. Control keys such as “ENTER”, “CARRIAGE RETURN”, etc., with functions substantially similar to conventional computer keyboards may or may not be explicitly implemented on the virtual keyboard. For example, in one embodiment, the user could indicate the ‘end of the word’ by pressing a key on the remote control mapped to that function. In another embodiment, the user could indicate the ‘end of the word’ by scrolling over to a corresponding key on the virtual keyboard and choosing it.

Application Hosting

It should be noted that a computer application embodying the present invention could be hosted on either a set-top appliance or one or more servers on the Internet or both. The present invention makes no assumption about centralized/distributed implementations of such an application. In an exemplary embodiment, the application is implemented on the set-top appliance so that the virtual dictionary consists of metadata keywords previously obtained by the set-top appliance. In another exemplary embodiment, at least some part of the application is implemented on a server communicatively connected with the set-top appliance via the Internet so that the search may encompass a more expansive dictionary of keywords, not necessarily limited to those downloaded previously to the set-top appliance.

In the foregoing specification, the invention has been described with reference to specific exemplary embodiments thereof. It will, however, be evident to those of ordinary skill in the art that various modifications and changes may be made thereto without departing from the broader spirit and scope of the invention as set forth in the appended claims. The specification and drawings are, accordingly, to be regarded in an illustrative rather than a restrictive sense and that it understood that the following claims including all equivalents are intended to define the scope of the invention.

What is claimed is:

1. A user interface, comprising:
a virtual dictionary containing keywords extracted from metadata describing multimedia content available for download to a set-top appliance communicatively coupled to a display device; and
a virtual keyboard of alphanumeric characters configured for display on the display device such that as a character is selected from the virtual keyboard using navigation and selection controls associated with the set-top appliance only those alphanumeric characters which appear in sequence in one or more of the keywords contained in the virtual dictionary are displayed on the display device for a next selection.

2. The user interface of claim 1, wherein the navigation and selection controls are included as part of a wireless remote control for the set-top appliance.

3. The user interface of claim 2, wherein the display device comprises a television.

4. The user interface of claim 3, wherein the virtual keyboard is displayed as an endless loop of the alphanumeric characters.

5. The user interface of claim 3, wherein the virtual keyboard is displayed as a grid of the alphanumeric characters.

6. The user interface of claim 3, wherein upon selection of a sufficient number of alphanumeric characters via the virtual keyboard such that only a single unique one of the keywords can be spelled thereby, the single unique keyword is presented for selection using the selection controls associated with the set-top appliance.

7. The user interface of claim 3, wherein the metadata collectively defines a program guide for Internet content.

8. The user interface of claim 3, wherein the virtual dictionary is stored on a computer-readable medium of the set-top appliance.

9. The user interface of claim 3, wherein the virtual dictionary is stored on a computer readable medium of a server remote from the set-top appliance but communicatively coupled thereto through one or more computer networks.

10. A method, comprising displaying, in response to a selection of an alphanumeric character from a virtual keyboard, only those alphanumeric characters which appear in sequence in one or more of keywords contained in a virtual dictionary, which keywords were extracted from metadata describing multimedia content available for download to a set-top appliance communicatively coupled to a display device on which the virtual keyboard is displayed.

11. The method of claim 10, wherein the selection is made using navigation and selection controls associated with the set-top appliance.

12. The method of claim 11, wherein the virtual keyboard is displayed as an endless loop of the alphanumeric characters.

13. The method of claim 11, wherein the virtual keyboard is displayed as a grid of the alphanumeric characters.

14. The method of claim 11, further comprising displaying a single unique one of the keywords for selection using the selection controls associated with the set-top appliance upon entry of a sufficient number of alphanumeric characters via the virtual keyboard such that only the single unique one of the keywords can be spelled thereby.

15. A method, comprising searching for multimedia content available for download via the Internet by entering a search query using a virtual keyboard of a set-top appliance, the virtual keyboard being displayed via a display device coupled to the set-top appliance and configured such that as each character is selected from the virtual keyboard only those alphanumeric characters which appear in sequence in one or more keywords contained in a virtual dictionary are displayed on the display device for a next selection.

16. The method of claim 15, wherein the keywords of the virtual dictionary are extracted from metadata describing the multimedia content available for download.

17. The method of claim 16, wherein upon entry of a sufficient number of the alphanumeric characters via the virtual keyboard such that only a single unique one of the keywords can be spelled thereby, the single unique keyword is presented for selection.

18. The method of claim 15, wherein the characters are selected from the virtual keyboard using a wireless remote control associated with the set-top appliance.

19. The method of claim 18, wherein the virtual keyboard is displayed as an endless loop of the alphanumeric characters.

20. The method of claim 18, wherein the virtual keyboard is displayed as a grid of the alphanumeric characters.
